(19) United States
(12) Patent Application Publication
(10) Pub. No.: US 2026/0112128 A1
(43) Pub. Date: Apr. 23, 2026

(54) METHOD FOR AUGMENTED REALITY, APPARATUS, DEVICE AND STORAGE MEDIUM

(71) Applicant: Beijing Zitiao Network Technology Co., Ltd., Beijing (CN)

(72) Inventors: Xing GAO, Beijing (CN); Huilin LIU, Beijing (CN)

(21) Appl. No.: 19/113,357

(22) PCT Filed: Aug. 30, 2023
(86) PCT No.: PCT/CN2023/115804

§ 371 Date: Mar. 19, 2025

(30) Foreign Application Priority Data
Sep. 21, 2022 (CN) 202211151653.0

(51) Int. Cl. G06T 19/00

(52) U.S. Cl. CPC G06T 19/006

(57) ABSTRACT

According to embodiments of the disclosure, a method for augmented reality, an apparatus, a device and a storage medium are provided. The method includes: determining a current distance between an electronic device for presenting an augmented reality scene and each virtual object of a plurality of virtual objects to be presented in the augmented reality scene; selecting at least a portion of the plurality of virtual objects based on the current distance; and rendering the at least a portion of the plurality of virtual objects in the augmented reality scene. In this way, at least a portion of a plurality of virtual objects can be dynamically loaded based on the current distance between the virtual object to be presented and the electronic device, improving the AR experience effect within a large activity range.

This application claims priority to Chinese Patent Application No. 202211151653.0, entitled “Method for Augmented Reality, Apparatus, Device and Storage Medium”, filed on Sep. 21, 2022. The entire contents of this Chinese patent application are incorporated herein by reference.

### FIELD

Example embodiments of the present disclosure generally relate to the field of computers, and in particular to method for augmented reality, apparatus, device and computer-readable storage medium.

### BACKGROUND

Augmented Reality (AR for short) technology is a technology that fuses virtual information with the real world. In the process of applying AR technology, the AR device can superimpose virtual objects and pictures in the real world and present them in the AR scene. In this way, the image appearing in the user's field of vision includes both the real world and virtual objects, so that the user can see both virtual objects and the real world at the same time. Conventional AR devices are usually suitable for users to experience within a small activity range, while the experience effect within a large activity range (such as streets or scenic areas) is not ideal.

### SUMMARY

In the first aspect of the present disclosure, a method for augmented reality is provided, comprising: determining a current distance between an electronic device for presenting an augmented reality scene and each virtual object of a plurality of virtual objects to be presented in the augmented reality scene; selecting at least a portion of the plurality of virtual objects based on the current distance; and rendering the at least a portion of the plurality of virtual objects in the augmented reality scene. In this way, at least a portion of a plurality of virtual objects can be dynamically loaded based on the current distance between the virtual object to be presented and the electronic device, improving the AR experience effect within a large activity range.

In the second aspect of the present disclosure, an apparatus for augmented reality is provided, comprising: a distance determination module, configured to determine a current distance between an electronic device for presenting an augmented reality scene and each virtual object of a plurality of virtual objects to be presented in the augmented reality scene; an object selection module, configured to select at least a portion of the plurality of virtual objects based on the current distance; and an object rendering module, configured to render the at least a portion of the plurality of virtual objects in the augmented reality scene. In this way, at least a portion of a plurality of virtual objects can be dynamically loaded based on the current distance between the virtual object to be presented and the electronic device, improving the AR experience effect within a large activity range.

In the third aspect of the present disclosure, an electronic device is provided. The device comprises at least one processing unit; and at least one memory coupled to the at least one processing unit and storing instructions for execution by the at least one processing unit. The instructions, when executed by the at least one processing unit, cause the device to perform the method of the first aspect.

In the fourth aspect of the present disclosure, a computer-readable storage medium is provided. The computer-readable storage medium stores a computer program, and the computer program can be executed by a processor to implement the method of the first aspect.

It should be understood that the content described in the content part of the present invention is not intended to limit the key features or important features of the embodiments of the present disclosure, nor is it used to limit the scope of the present disclosure. Other features of the present disclosure will become readily understood through the following description.

### BRIEF DESCRIPTION OF DRAWINGS

In combination with the accompanying drawings and referring to the following detailed descriptions, the above and other features, advantages, and aspects of various embodiments of the present disclosure will become more apparent. In the drawings, the same or similar reference numerals indicate the same or similar elements, wherein:

FIG. 1 illustrates a schematic diagram of an example environment in which embodiments of the present disclosure can be implemented;

FIG. 2 illustrates a flowchart of a method for augmented reality according to embodiments of the present disclosure;

FIG. 3 illustrates a schematic diagram of an AR scene according to some embodiments of the present disclosure;

FIG. 4 illustrates a schematic diagram of an AR scene according to some embodiments of the present disclosure;

FIG. 5 illustrates a schematic diagram of an AR scene according to some embodiments of the present disclosure;

FIG. 6 illustrates a schematic diagram of an AR scene according to some embodiments of the present disclosure;

FIG. 7 illustrates a block diagram of an apparatus for augmented reality according to some embodiments of the present disclosure; and

FIG. 8 illustrates a block diagram of a device capable of implementing multiple embodiments of the present disclosure.

### DETAILED DESCRIPTION

The embodiments of the present disclosure will be described in more detail below with reference to the accompanying drawings. Although certain embodiments of the present disclosure are shown in the drawings, it would be appreciated that the present disclosure can be implemented in various forms and should not be interpreted as limited to the embodiments described in this specification. On the contrary, these embodiments are provided for a more thorough and complete understanding of the present disclosure. It would be appreciated that the accompanying drawings and embodiments of the present disclosure are only for the purpose of illustration and are not intended to limit the scope of protection of the present disclosure.

In the description of the embodiments of the present disclosure, the term “including” and similar terms would be appreciated as open-ended inclusion, that is, “including but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below.

As briefly mentioned above, conventional AR devices are usually suitable for users to experience within a small activity range, while the experience effect within a large activity range (such as streets or scenic areas) is not ideal. For example, when a user experiences AR within a large activity range, in order to ensure richness of the AR effect, the AR device needs to load a large number of virtual objects (also be referred to as AR special effects or AR elements) in the AR scene at various positions within the activity range, which not only requires to consume a large amount of processing performance of the AR device, but also causes unclear primary and secondary visual effects when virtual objects in the near and far are simultaneously visible. In addition, when the user experiences AR within a large activity range, if a large number of two-dimensional (2D) and three-dimensional (3D) virtual object materials required are all pre-installed in the special effect package of the AR device, the volume of the special effect package will be too large, and it is possible that materials that are not used will be downloaded for the user when the user does not experience at a specific position or at a specific time, affecting the performance of the AR device.

Embodiments of the present disclosure propose a scheme for selectively downloading and loading AR elements related to positions in an AR scene according to the position of an electronic device within a large activity range. In this scheme, for a plurality of virtual objects to be presented in the AR scene, at least a portion of the plurality of virtual objects can be dynamically loaded based on the current distance between each virtual object and the electronic device for presenting the AR scene, thereby improving the AR experience effect within a large activity range. The scheme proposed by the embodiments of the present disclosure can be applied to various AR experience scenarios, for example, it can be used to experience AR special effects in applications on electronic devices or experience AR content in AR glasses.

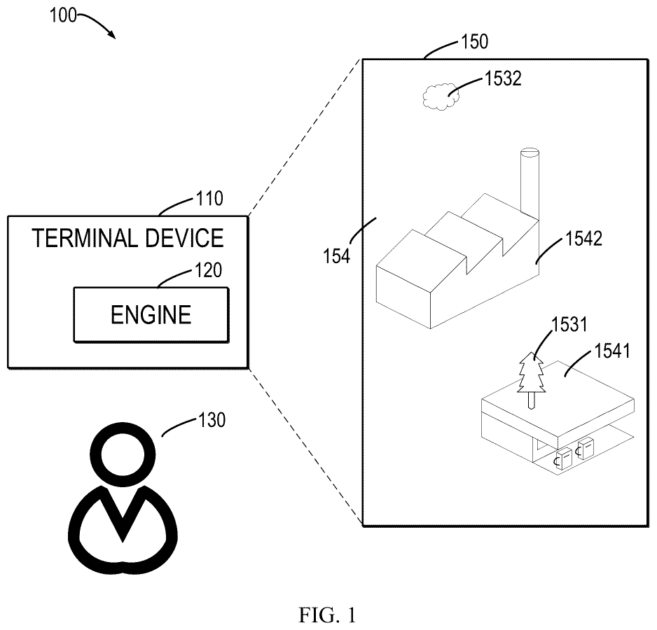

FIG. 1 illustrates a schematic diagram of an example environment 100 in which embodiments of the present disclosure can be implemented. In this example environment 100, the AR scene 150 is presented to the user 130 at or by the terminal device 110. The AR scene 150 can be presented on the screen of the terminal device 110. The AR scene 150 may include a real-world picture 154 and virtual objects 1531 and 1532.

In the picture 154, objects 1541 and 1542 are representations of real objects (in this example, buildings) in the real world in the AR scene 150, such as images or other forms of representation of real objects. For ease of discussion only, objects 1541 and 1542 are also referred to herein as 3D objects. When a user experiences AR within a large activity range, the picture 154 may change as the position and/or the viewing angle of the terminal device 110 changes, and accordingly, the 3D objects presented in the picture 154 will also change.

In this example, virtual objects 1531 and 1532 are specifically AR objects, and these virtual objects are superimposed on the real-world picture 154. For example, the virtual object 1531 can be used to represent a plant that can be placed on a building, and the virtual object 1532 may be used to represent a cloud floating in the sky.

It should be understood that the AR scene 150 is merely exemplary and is not intended to limit the scope of the present disclosure. The AR scene 150 may include more or fewer virtual objects superimposed on the picture 154, or may include other elements, such as user interface (UI) elements.

The terminal device 110 can be any type of mobile terminal, fixed terminal, or portable terminal, including a mobile phone, a desktop computer, a laptop computer, a notebook computer, a netbook computer, a tablet computer, a media computer, a multimedia tablet, a gaming device, a wearable device, a personal communication system (PCS) device, a personal navigation device, a personal digital assistant (PDA), an audio/video player, a digital camera/camcorder, a pointing device, a television receiver, a radio broadcast receiver, an electronic book device, or any combination of the foregoing, including accessories and peripherals of these devices, or any combination thereof. In some embodiments, the terminal device 110 may also support any type of interface for users (such as “wearable” circuitry, etc.).

An engine 120 is installed in the terminal device 110. The engine 120 is used to drive presentation of the AR scene 150. In some examples, the engine 120 may be an AR game engine, and accordingly, the AR scene 150 may be an AR game scene. In some embodiments, the engine 120 may be part of a content sharing application that can provide the user 130 with services related to multimedia content consumption, including browsing, commenting, reposting, creating (e.g., shooting and/or editing), publishing, etc. of multimedia content. Accordingly, the AR scene 150 may be an AR content creation scene.

It should be understood that the structure and function of the environment 100 are described for exemplary purposes only and do not imply any limitation on the scope of the present disclosure. The terminal device 110 may include any suitable structure and function to implement the presentation of virtual objects in the AR scene when the user experiences AR within a large activity range.

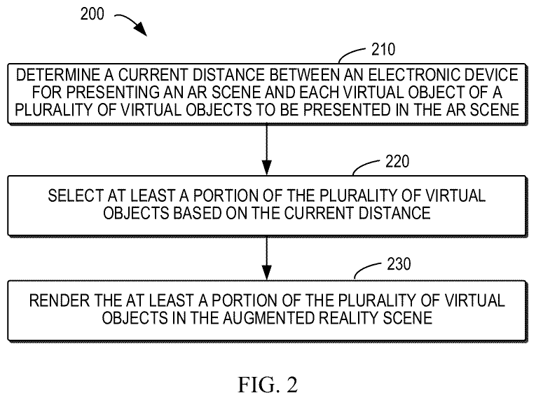

FIG. 2 illustrates a flowchart of a method 200 for augmented reality according to embodiments of the present disclosure. The method 200 may be implemented at the terminal device 110. For ease of discussion, the method 200 will be described with reference to the environment 100 of FIG. 1.

At block 210, the terminal device 110 determines a current distance between an electronic device for presenting an AR scene and each virtual object of a plurality of virtual objects to be presented in the AR scene. As described above, the terminal device 110 is used to present the AR scene 150. Therefore, the terminal device 110 is herein used as an electronic device for presenting an AR scene. When the user uses the terminal device 110 to experience AR within a predetermined geographical area, the terminal device 110 may load corresponding virtual objects among the plurality of virtual objects to be presented in the AR scene 150 at different positions. In embodiments of the present disclosure, the predetermined geographical area may be a large activity range or a small activity range, which is not limited in the embodiments of the present disclosure.

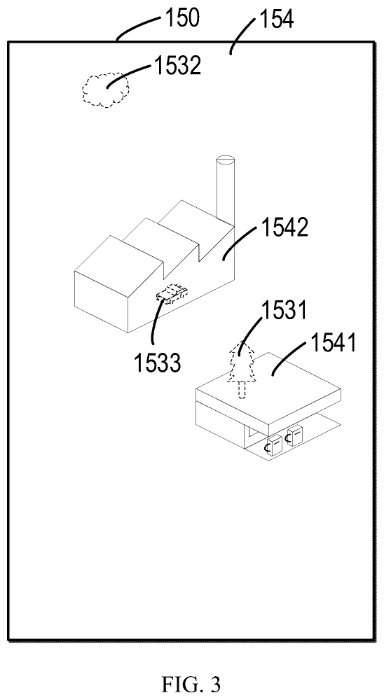

FIG. 3 illustrates a schematic diagram of the AR scene 150 according to some embodiments of the present disclosure. As shown in FIG. 3, when the terminal device 110 is at a certain position within the predetermined geographical area, the real-world picture 154 is presented in the AR scene 150, and the picture 154 contains 3D objects 1541 and 1542, which are buildings in this example. In other examples, the picture 154 may alternatively or additionally contain other types of 3D objects. In addition, for ease of understanding, some part of the plurality of virtual objects to be loaded in the AR scene 150, such as virtual objects 1531, 1532 and 1533, are shown in the form of dashed lines in the presented AR scene 150. In other words, virtual objects 1531, 1532 and 1533 have not been presented in the AR scene 150, but can be presented in the AR scene 150 when the terminal device 110 is at a specific position. The virtual object 1531 may be, for example, a plant placed on the 3D object 1541, the virtual object 1532 may be, for example, a cloud floating in the sky, and the virtual object 1533 may be, for example, a vehicle placed on the 3D object 1542.

As described above, when the user uses the terminal device 110 to experience AR within a predetermined geographical area, the terminal device 110 may load corresponding virtual objects in the AR scene 150 at different positions. For the predetermined geographical area, the terminal device 110 may download a configuration file of the plurality of virtual objects to be presented in the AR scene 150 from a server (such as a cloud platform or other types of servers) during AR experience or pre-store it in the terminal device 110. In some embodiments, the configuration file may store at least one piece of the following information of each virtual object: a visible distance, a visible time period, a coordinate, a dimension, a direction, and a resource download path. In some embodiments, a configuration file in Json format may be used to store the above information.

The visible distance indicates that the corresponding virtual object can be presented in the AR scene 150 in the case that the distance from the terminal device 110 is less than the visible distance and cannot be presented in the AR scene 150 in the case that it is greater than the visible distance. In the AR scene 150 shown in FIG. 3, the distance between each of the virtual objects 1531, 1532 and 1533 and the terminal device 110 is greater than the corresponding visible distance, so they are in an invisible state in the AR scene 150, that is, they are not presented in the AR scene 150.

The visible time period indicates that the corresponding virtual object can be presented in the AR scene 150 within the visible time period and cannot be presented in the AR scene 150 outside the visible time period. For example, for the virtual object 1531, its visible time period may be set from 8 am to 6 pm, and when experiencing AR within the predetermined geographical area using the terminal device 110 within the visible time period, the virtual object 1531 can be presented in the AR scene 150, and outside the visible time period, the virtual object 1531 cannot be presented in the AR scene 150.

The coordinate indicates the loading position of the corresponding virtual object in the AR scene 150. For example, for the virtual object 1531 shown in FIG. 3, the loading position indicated by its coordinates is on the 3D object 1541 in the AR scene 150. For the virtual object 1532 shown in FIG. 3, the loading position indicated by its coordinates is in the sky in the AR scene 150. For the virtual object 1533 shown in FIG. 3, the loading position indicated by its coordinates is on the 3D object 1542 in the AR scene 150.

The dimension indicates the loading size of the corresponding virtual object in the AR scene 150. For example, for the virtual object 1531 shown in FIG. 3, it can be loaded on the 3D object 1541 with the loading size represented by its dimension. For the virtual object 1532 shown in FIG. 3, it can be loaded in the sky of the AR scene 150 with the loading size represented by its dimension. For the virtual object 1533 shown in FIG. 3, it can be loaded on the 3D object 1542 with the loading size represented by its dimension.

The direction indicates the loading orientation of the corresponding virtual object in the AR scene 150 and is used to set whether the virtual object always faces the camera of the terminal device 110. For example, for the virtual object 1531 shown in FIG. 3, it can be loaded on the 3D object 1541 with the loading orientation represented by its direction. For the virtual object 1532 shown in FIG. 3, it can be loaded in the sky of the AR scene 150 with the loading orientation represented by its direction. For the virtual object 1533 shown in FIG. 3, it can be loaded on the 3D object 1542 with the loading orientation represented by its direction.

The resource download path indicates the path when downloading the corresponding virtual object from the server. When a virtual object needs to be downloaded, the resource file of the virtual object, such as 2D materials or 3D materials, may be downloaded from the server according to the resource download path.

In some embodiments, for a predetermined geographical area, a special effects editor may edit a dynamic resource package in the electronic device, and the dynamic resource package contains the configuration file as described above and the resource file of each virtual object. For example, the configuration file may be a configuration file in Json format, which may store at least one piece of the following information of each virtual object: an object name, an object type, a coordinate, a dimension, a rotation angle, a visible distance, a visible time period, a rendering blend mode, a direction, and a resource download path. The resource files may be 2D materials or 3D materials, such as pictures, sequence frames, 3D models, and textures. When editing the dynamic resource package, the editor may place virtual objects at corresponding positions according to the map and model of the predetermined geographical area. For example, a corresponding instance may be created at a corresponding coordinate of each virtual object, and the instance has a script with a custom user interface, and the editor can specify the specific information of the instance in the user interface, such as the information contained in the configuration file as described above. Subsequently, the edited dynamic resource package may be uploaded to a server, such as a cloud platform. The server may distribute the configuration file and the resource file contained in the dynamic resource package according to the request of the terminal device 110. By using a fixed and matched script and configuration file, unified editing and management of large-scene AR props can be achieved.

In some embodiments, the terminal device 110 may take pictures within a predetermined geographical area and determine the position of the terminal device 110 within the predetermined geographical area based on the captured pictures. For example, the terminal device 110 may download or pre-store a map and a feature point cloud model corresponding to the predetermined geographical area, and the feature point cloud model is used to model objects within the predetermined geographical area. When the terminal device 110 captures a picture within the predetermined geographic area, the captured picture may be compared with the object represented by the feature point cloud model to determine the position of the terminal device 110 within the predetermined geographic area. In some embodiments, the terminal device 110 may determine the position of the terminal device 110 within the predetermined geographical area further based on global positioning system (GPS) information. In this way, the position of the terminal device 110 can be accurately determined.

In the case that the position of the terminal device 110 is determined, the terminal device 110 may traverse the configuration file of each virtual object in the plurality of virtual objects to be loaded in the AR scene 150 to determine the current distance between each virtual object and the terminal device 110 according to the position of the terminal device 110 within the predetermined geographic area and the coordinates of each virtual object. For example, the terminal device 110 may determine the current distance between each virtual object of the virtual objects 1531, 1532, and 1533 and other virtual objects and the terminal device 110.

At block 220, the terminal device 110 selects at least a portion of the plurality of virtual objects based on the current distance between each virtual object and the terminal device 110. The terminal device 110 may adopt any suitable strategy to select the at least a portion of the plurality of virtual objects for rendering in AR scene 150.

In some embodiments, the terminal device 110 compares the current distance between each virtual object and the terminal device 110 with the corresponding visible distance. If the current distance between the first portion of the plurality of virtual objects and the terminal device 110 is less than the corresponding visible distance, the terminal device 110 selects the first portion as the at least a portion of the plurality of virtual objects for rendering in the AR scene 150. For example, for the virtual objects 1531, 1532, and 1533 shown in FIG. 3, if as terminal device 110 moves within the predetermined geographical area, the current distance between one or more virtual objects among virtual objects 1531, 1532 and 1533 and the terminal device 110 is less than the corresponding visible distance, then select the one or more virtual objects for rendering in the AR scene 150.

In some embodiments, the terminal device 110 selects at least a portion for rendering in the AR scene 150 further based on the visible time period of each virtual object of the plurality of virtual objects to be rendered in the AR scene 150. For example, if the current distance between the first portion of the plurality of virtual objects and the terminal device 110 is less than the corresponding visible distance, then the terminal device 110 may further determine whether each virtual object in the first portion is within the visible time period. The terminal device 110 may select virtual objects within the visible time period in the first portion for rendering in the AR scene 150, and not select virtual objects outside the visible time period in the first portion.

At block 230, the terminal device 110 renders the selected at least a portion of the plurality of virtual objects in the AR scene 150.

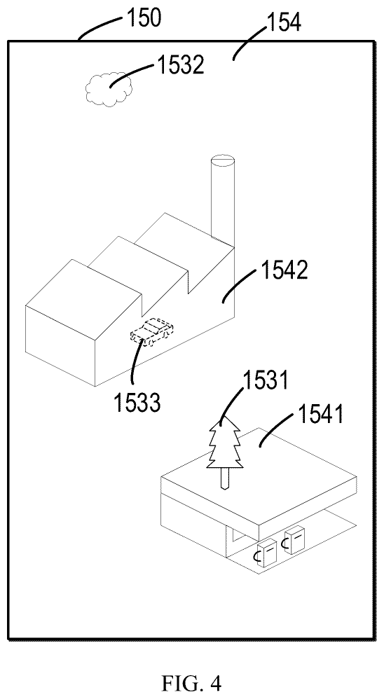

FIG. 4 illustrates a schematic diagram of the AR scene 150 according to some embodiments of the present disclosure. The AR scenario 150 shown in FIG. 4 is the scene presented on the terminal device 110 after the terminal device 110 changes its position from the position corresponding to the AR scene 150 in FIG. 3 in a predetermined geographical area. When the terminal device 110 is at the current position corresponding to the AR scene in FIG. 4, the current distance between virtual objects 1531 and 1532 and the terminal device 110 is less than the corresponding visible distance, while the current distance between the virtual object 1533 and the terminal device 110 is greater than the corresponding visible distance, or the current distances between virtual objects 1531, 1532, and 1533 and the terminal device 110 are all less than the corresponding visible distances, but virtual objects 1531 and 1532 are within the visible time period, while the virtual object 1533 is outside the visible time period. Therefore, the terminal device 110 may select virtual objects 1531 and 1532 in the manner described above in connection with block 220 and render virtual objects 1531 and 1532 (shown in solid lines in FIG. 4) in the AR scene 150 using the corresponding resource files, and not render the virtual object 1533 (shown in dashed lines in FIG. 4).

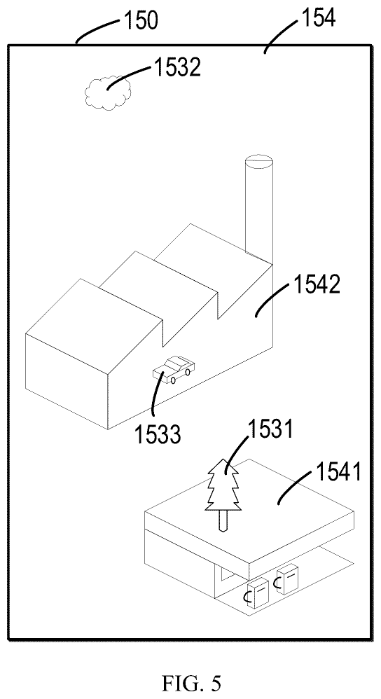

FIG. 5 illustrates a schematic diagram of the AR scene 150 according to some embodiments of the present disclosure. The AR scene 150 shown in FIG. 5 is the scene presented on the terminal device 110 after the terminal device 110 changes its position from the position corresponding to the AR scene 150 in FIG. 3 or FIG. 5 within a predetermined geographical area. When the terminal device 110 is at the current position corresponding to the AR scene in FIG. 5, the current distances between virtual objects 1531, 1532, and 1533 and the terminal device 110 are all less than the corresponding visible distance, and virtual objects 1531, 1532, and 1533 are all within the corresponding visible time periods. Therefore, the terminal device 110 may select virtual objects 1531, 1532, and 1533 in the manner described above in connection with block 220, and render virtual objects 1531, 1532, and 1533 (shown in solid lines in FIG. 5) in the AR scene 150 using the corresponding resource files.

In some embodiments, when a user uses the terminal device 110 to experience AR within a predetermined geographical area, the terminal device 110 may automatically refresh at certain time intervals, and dynamically load virtual objects in the AR scene 150 according to the current position of the terminal device 110 and the system time. For example, the terminal device 110 may use a script to read the information in the Json configuration file in turn, if the coordinate value of a virtual object is less than the corresponding visible distance from the terminal device 110 and the system time is within the corresponding visible time period, an instance of the corresponding virtual object will be created in the AR scene 150, and the rendering blend mode and orientation used for rendering will be set according to the value specified in the Json configuration file. If there is already an instance of a certain virtual object in the AR scene 150 and the distance between the virtual object and the terminal device 110 has exceeded the visible distance, then delete the instance of the virtual object from the AR scene 150. If there is already an instance of a certain virtual object in the AR scene 150 and after refreshing and the distance between the virtual object and the terminal device 110 is still less than the visible distance, then the instance of the virtual object remains unchanged in the AR scene 150.

In embodiments of the present disclosure, by dynamically loading at least a portion of the plurality of virtual objects based on the current distance between the virtual object to be presented and the electronic device, on the one hand, it may avoid the unclear primary and secondary visual effects caused by the simultaneous visibility of virtual objects in the near and far, and on the other hand, it may avoid affecting the performance of the terminal device 110 due to loading a large number of virtual objects, thereby improving the AR experience effect within a large activity range.

In some embodiments, when rendering the selected at least a portion of the virtual objects among the plurality of virtual objects in AR scene 150, if the resource file of one or more virtual objects in the selected at least a portion of the virtual objects have not been downloaded, then the terminal device 110 sends a request to the server to download the resource file of the one or more virtual objects. Subsequently, the terminal device 110 receives the resource file of the one or more virtual objects from the server for rendering in AR scene 150. On the contrary, for the virtual object in the selected at least a portion of the virtual objects whose resource file has been downloaded, there is no need to download it again.

The terminal device 110 may save the newly downloaded resource file as an element, for example, stored in a table. In this way, the terminal device 110 may determine whether the resource file of each virtual object has been downloaded according to the elements stored in the table. If it has been downloaded, it will not be downloaded again. In this way, when the terminal device 110 starts to present the AR scene 150, it does not need to download the resource file of all virtual objects to be presented in the AR scene 150, but only needs to download the configuration files of the virtual objects. As the terminal device 110 changes its position within the predetermined geographical area, the terminal device 110 can dynamically load the resource file of virtual objects, saving the storage space of the terminal device 110 and improving the performance of the terminal device 110.

As the terminal device 110 changes its position within the predetermined geographical area, the current distance between some virtual objects and the terminal device 110 may change from being less than the visible distance to being greater than the visible distance. In this case, the virtual objects whose current distance changes from being less than the visible distance to being greater than the visible distance may be removed from the AR scene 150. In other words, the terminal device 110 may select at least a portion that should no longer be rendered from the virtual objects rendered in the AR scene 150 based on the current distance of the virtual object rendered in the AR scene 150 and remove at least a portion that should no longer be rendered from the AR scene 150.

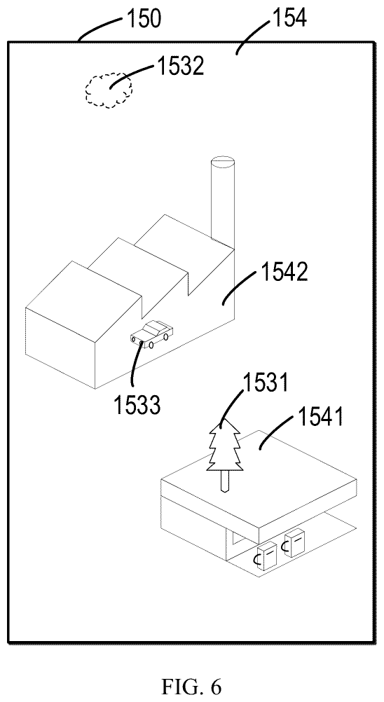

In some embodiments, the terminal device 110 compares the current distance between each virtual object rendered in the AR scene 150 and the terminal device 110 with the corresponding visible distance, and in response to the current distance of the second portion of the virtual objects rendered in the AR scene 150 being greater than the corresponding visible distance, selects the second portion for removal from the AR scene 150. FIG. 6 illustrates a schematic diagram of the AR scene 150 according to some embodiments of the present disclosure. The AR scene 150 shown in FIG. 6 is the scene presented on the terminal device 110 after the terminal device 110 changes its position from the position corresponding to the AR scene 150 in FIG. 5 within a predetermined geographical area. When the terminal device 110 changes its position from the position corresponding to the AR scene in FIG. 5 to the position corresponding to the AR scene in FIG. 6, the current distances between virtual objects 1531 and 1533 and the terminal device 110 are still less than the corresponding visible distances, while the current distance between virtual object 1532 and terminal device 110 changes from being less than the visible distance to being greater than the visible distance. Therefore, the terminal device 110 may remove the virtual object 1532 from the AR scene 150 (shown in dashed lines in FIG. 6).

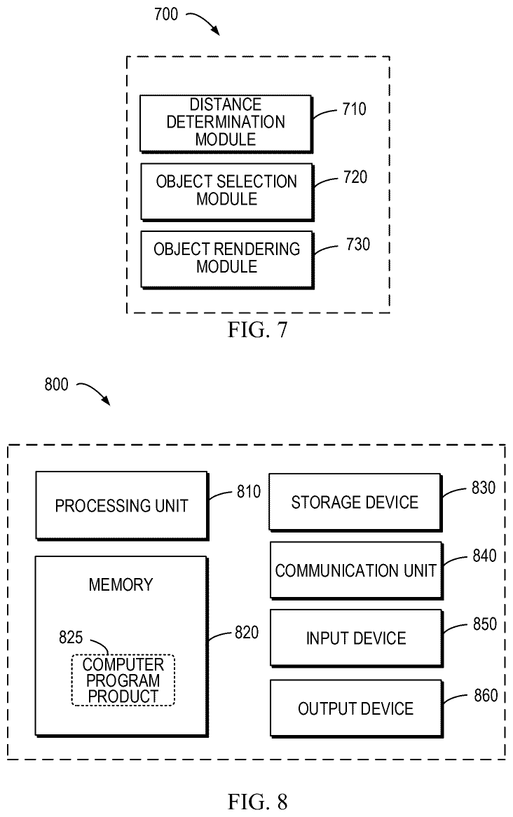

FIG. 7 illustrates a schematic structural block diagram of an apparatus 700 for augmented reality according to some embodiments of the present disclosure. The apparatus 700 may be implemented as or included in the terminal device 110. Each module/component in the apparatus 700 may be implemented by hardware, software, firmware, or any combination thereof.

As shown, the apparatus 700 comprises: a distance determination module 710, configured to determine a current distance between an electronic device for presenting an augmented reality scene and each virtual object of a plurality of virtual objects to be presented in the augmented reality scene; an object selection module 720, configured to select at least a portion of the plurality of virtual objects based on the current distance; and an object rendering module 730, configured to render the at least a portion of the plurality of virtual objects in the augmented reality scene.

In some embodiments, the object rendering module 730 is further configured to: in response to determining that a resource file of one or more virtual objects of the selected at least a portion of the plurality of virtual objects have not been downloaded, send a request to download the resource file of the one or more virtual objects; and receive the resource file of the one or more virtual objects for rendering.

In some embodiments, the object selection module 720 is further configured to: compare the current distance of each virtual object of the plurality of virtual objects with a corresponding visible distance; and in response to the current distance of a first portion of the plurality of virtual objects being less than a corresponding visible distance, select the first portion.

In some embodiments, the apparatus 700 further comprises: a second object selection module, configured to select, based on the current distance, at least a portion that should no longer be rendered from virtual objects rendered in the augmented reality scene; and an object removal module, configured to remove the at least a portion that should no longer be rendered from the augmented reality scene.

In some embodiments, the second object selection module is further configured to: compare the current distance of each virtual object rendered in the augmented reality scene with a corresponding visible distance; and in response to the current distance of a second portion of virtual objects rendered in the augmented reality scene being greater than a corresponding visible distance, select the second portion.

In some embodiments, the object selection module 720 is further configured to select the at least a portion for rendering further based on a visible time period of each virtual object of the plurality of virtual objects.

In some embodiments, the object rendering module 730 is further configured to perform the rendering based on a configuration file associated with the plurality of virtual objects, the configuration file describing at least one of: a visible time period, a coordinate, a dimension, a direction, and a resource download path.

FIG. 8 illustrates a block diagram of an electronic device 800 in which one or more embodiments of the present disclosure may be implemented. It should be understood that the electronic device 800 shown in FIG. 8 is merely exemplary and should not constitute any limitation on the functions and scopes of the embodiments described herein. The electronic device 800 shown in FIG. 8 may be used to implement the terminal device 110 in FIG. 1.

As shown in FIG. 8, the electronic device 800 is in the form of a general-purpose electronic device. Components of the electronic device 800 may include, but are not limited to, one or more processors or processing units 810, a memory 820, a storage device 830, one or more communication units 840, one or more input devices 850, and one or more output devices 860. The processing unit 810 may be an actual or virtual processor capable of performing various processes according to a program stored in the memory 820. In a multiprocessor system, a plurality of processing units executes computer-executable instructions in parallel to improve the parallel processing capabilities of electronic device 800.

The electronic device 800 typically includes a variety of computer storage media. Such media may be any available media that are accessible to the electronic device 800, including, but not limited to, volatile and non-volatile media, removable and non-removable media. The memory 820 may be a volatile memory (e.g., a register, cache, random access memory (RAM)), non-volatile memory (e.g., read-only memory (ROM), electrically erasable programmable read-only memory (EEPROM), flash memory), or some combination thereof. The storage device 830 may be a removable or non-removable medium and may include a machine-readable medium, such as a flash drive, magnetic disk, or any other medium that can be used to store information and/or data and that can be accessed within the electronic device 800.

The electronic device 800 may further include an additional removable/non-removable, volatile/non-volatile storage medium. Although not shown in FIG. 8, a disk drive for reading from or writing to a removable, non-volatile magnetic disk (e.g., a “floppy disk”) or an optical disk drive for reading from or writing to a removable, non-volatile optical disk may be provided. In these cases, each drive may be connected to a bus (not shown) by one or more data media interfaces. The memory 820 may include a computer program product 825 having one or more program modules configured to execute various methods or actions of the various embodiments of the present disclosure.

The communication unit 840 is configured to communicate with other electronic devices through a communication medium. Additionally, the functionality of components of the electronic device 800 may be implemented by a single computing cluster or multiple computing machines capable of communicating through a communication connection. Thus, the electronic device 800 may operate in a networked environment using a logical connection with one or more other servers, network personal computers (PCs), or another network node.

The input device 850 may be one or more input devices such as a mouse, a keyboard, a trackball, or the like. The output device 860 may be one or more output devices, such as a display, a speaker, a printer, or the like. The electronic device 800 may also communicate with one or more external devices (not shown) through the communication unit 840 as needed. The external device, such as a storage device, a display device, etc., communicates with one or more devices that enable users to interact with the electronic device 800, or communicates with any device (e.g., a network card, a modem, etc.) that enables the electronic device 800 to communicate with one or more other electronic devices. Such communication may be performed via an input/output (I/O) interface (not shown).

According to example implementations of the present disclosure, a computer-readable storage medium having computer-executable instructions stored thereon is provided. The computer-executable instructions are executed by a processor to implement the method described above. According to example implementations of the present disclosure, a computer program product is further provided. The computer program product is tangibly stored on a non-transitory computer-readable medium and includes computer-executable instructions. The computer-executable instructions are executed by a processor to implement the method described above.

Various aspects of the present disclosure are described herein with reference to flowcharts and/or block diagrams of methods, apparatuses, devices, and computer program products implemented according to the present disclosure. It would be appreciated that each block of the flowchart and/or block diagram, and combinations of blocks in the flowcharts and/or block diagrams, may be implemented by computer readable program instructions.

These computer-readable program instructions may be provided to a processing unit of a general-purpose computer, special computer, or other programmable data processing apparatus to produce a machine that generates an apparatus to implement the functions/acts specified in one or more blocks in the flowchart and/or the block diagram when these instructions are executed through the processing units of the computer or other programmable data processing devices. These computer-readable program instructions may also be stored in a computer-readable storage medium. These instructions cause the computer, programmable data processing apparatus, and/or other devices to work in a specific way. Therefore, the computer-readable medium storing instructions includes an article of manufacture including instructions to implement aspects of the functions/acts specified in one or more blocks in the flowchart and/or block diagram(s).

The computer-readable program instructions may be loaded onto a computer, a programmable data processing apparatus, or a further device, such that a series of operational steps can be performed on the computer, programmable data processing apparatus, or the further device to produce a computer-implemented process. As such, the instructions executed on the computer, programmable data processing apparatus, or the further device implement the functions/acts specified in the one or more blocks in the flowchart and/or block diagram(s).

The flowchart and block diagrams in the drawings show the possible architecture, functions and operations of the system, the method, and the computer program product implemented according to various implementations of the present disclosure. In this regard, each block in the flowchart or block diagram may represent a part of a module, a program segment or instructions, which contains one or more executable instructions for implementing the specified logic function(s). In some alternative implementations, the functions marked in the blocks may also occur in a different order from those marked in the drawings. For example, two consecutive blocks may be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by a combination of a dedicated hardware and computer instructions.

Various implementations of the present disclosure have been described above. The above description is exemplary, not exhaustive, and the present application is not limited to the disclosed implementations. Without departing from the scope and spirit of the described implementations, many modifications and changes are obvious to those skilled in the art. The terminology used herein has been chosen to best explain the principles of the respective implementations, the practical applications or improvements to the technology in the marketplace, or to enable those skilled in the art to understand the implementations disclosed herein.

1-11. (canceled)

12. A method for augmented reality, comprising:
determining a current distance between an electronic device for presenting an augmented reality scene and each virtual object of a plurality of virtual objects to be presented in the augmented reality scene;
selecting at least a portion of the plurality of virtual objects based on the current distance; and
rendering the at least a portion of the plurality of virtual objects in the augmented reality scene.

13. The method of claim 12, wherein rendering the at least a portion of the plurality of virtual objects in the augmented reality scene comprises:
in response to determining that a resource file of one or more virtual objects of the selected at least a portion of the plurality of virtual objects have not been downloaded, sending a request to download the resource file of the one or more virtual objects; and
receiving the resource file of the one or more virtual objects for rendering.

14. The method of claim 12, wherein selecting at least a portion of the plurality of virtual objects comprises:
comparing the current distance of each virtual object of the plurality of virtual objects with a corresponding visible distance; and
in response to the current distance of a first portion of the plurality of virtual objects being less than a corresponding visible distance, selecting the first portion.

15. The method of claim 12, further comprising:
selecting, based on the current distance, at least a portion that should no longer be rendered from virtual objects rendered in the augmented reality scene; and
removing the at least a portion that should no longer be rendered from the augmented reality scene.

16. The method of claim 15, wherein selecting at least a portion that should no longer be rendered from virtual objects rendered in the augmented reality scene comprises:
comparing the current distance of each virtual object rendered in the augmented reality scene with a corresponding visible distance; and
in response to the current distance of a second portion of virtual objects rendered in the augmented reality scene being greater than a corresponding visible distance, selecting the second portion.

17. The method of claim 12, wherein selecting at least a portion of the plurality of virtual objects comprises:
selecting the at least a portion for rendering further based on a visible time period of each virtual object of the plurality of virtual objects.

18. The method of claim 12, wherein rendering the at least a portion of the plurality of virtual objects in the augmented reality scene comprises:
performing the rendering based on a configuration file associated with the plurality of virtual objects, the configuration file describing at least one of: a visible time period, a coordinate, a dimension, a direction, and a resource download path.

19. An electronic device, comprising:
at least one processing unit; and
at least one memory coupled to the at least one processing unit and storing instructions for execution by the at least one processing unit, the instructions, when executed by the at least one processing unit, causing the device to perform acts comprising:
determining a current distance between an electronic device for presenting an augmented reality scene and each virtual object of a plurality of virtual objects to be presented in the augmented reality scene;
selecting at least a portion of the plurality of virtual objects based on the current distance; and
rendering the at least a portion of the plurality of virtual objects in the augmented reality scene.

20. The device of claim 19, wherein rendering the at least a portion of the plurality of virtual objects in the augmented reality scene comprises:
in response to determining that a resource file of one or more virtual objects of the selected at least a portion of the plurality of virtual objects have not been downloaded, sending a request to download the resource file of the one or more virtual objects; and
receiving the resource file of the one or more virtual objects for rendering.

21. The device of claim 19, wherein selecting at least a portion of the plurality of virtual objects comprises:
comparing the current distance of each virtual object of the plurality of virtual objects with a corresponding visible distance; and
in response to the current distance of a first portion of the plurality of virtual objects being less than a corresponding visible distance, selecting the first portion.

22. The device of claim 19, further comprising:
selecting, based on the current distance, at least a portion that should no longer be rendered from virtual objects rendered in the augmented reality scene; and
removing the at least a portion that should no longer be rendered from the augmented reality scene.

23. The device of claim 22, wherein selecting at least a portion that should no longer be rendered from virtual objects rendered in the augmented reality scene comprises:
comparing the current distance of each virtual object rendered in the augmented reality scene with a corresponding visible distance; and
in response to the current distance of a second portion of virtual objects rendered in the augmented reality scene being greater than a corresponding visible distance, selecting the second portion.

24. The device of claim 19, wherein selecting at least a portion of the plurality of virtual objects comprises:
selecting the at least a portion for rendering further based on a visible time period of each virtual object of the plurality of virtual objects.

25. The device of claim 19, wherein rendering the at least a portion of the plurality of virtual objects in the augmented reality scene comprises:
performing the rendering based on a configuration file associated with the plurality of virtual objects, the configuration file describing at least one of: a visible time period, a coordinate, a dimension, a direction, and a resource download path.

26. A non-transitory computer-readable storage medium having stored thereon a computer program, which, when executed by a processor, implements a method comprising:
determining a current distance between an electronic device for presenting an augmented reality scene and each virtual object of a plurality of virtual objects to be presented in the augmented reality scene;
selecting at least a portion of the plurality of virtual objects based on the current distance; and
rendering the at least a portion of the plurality of virtual objects in the augmented reality scene.

27. The medium of claim 26, wherein rendering the at least a portion of the plurality of virtual objects in the augmented reality scene comprises:
in response to determining that a resource file of one or more virtual objects of the selected at least a portion of the plurality of virtual objects have not been downloaded, sending a request to download the resource file of the one or more virtual objects; and
receiving the resource file of the one or more virtual objects for rendering.

28. The medium of claim 26, wherein selecting at least a portion of the plurality of virtual objects comprises:
comparing the current distance of each virtual object of the plurality of virtual objects with a corresponding visible distance; and
in response to the current distance of a first portion of the plurality of virtual objects being less than a corresponding visible distance, selecting the first portion.

29. The medium of claim 26, further comprising:
selecting, based on the current distance, at least a portion that should no longer be rendered from virtual objects rendered in the augmented reality scene; and
removing the at least a portion that should no longer be rendered from the augmented reality scene.

30. The medium of claim 29, wherein selecting at least a portion that should no longer be rendered from virtual objects rendered in the augmented reality scene comprises:
comparing the current distance of each virtual object rendered in the augmented reality scene with a corresponding visible distance; and
in response to the current distance of a second portion of virtual objects rendered in the augmented reality scene being greater than a corresponding visible distance, selecting the second portion.

31. The medium of claim 26, wherein selecting at least a portion of the plurality of virtual objects comprises:
selecting the at least a portion for rendering further based on a visible time period of each virtual object of the plurality of virtual objects.
